(19) United States
(12) Patent Application Publication
(10) Pub. No.: US 2025/0329564 A1
(43) Pub. Date: Oct. 23, 2025

(54) COMPUTER PROGRAM, ANALYSIS METHOD, AND ANALYZER

(71) Applicant: Tokyo Electron Limited, Tokyo (JP)

(72) Inventors: Daisuke OBA, Sapporo City (JP); Takahiro NAKAMURA, Sapporo City (JP); Masaki KITSUNEZUKA, Sapporo City (JP); Tsutomu MURATA, Sapporo City (JP); Norifumi OHMI, Sapporo City (JP)

(73) Assignee: Tokyo Electron Limited, Tokyo (JP)

(21) Appl. No.: 19/258,918

(22) Filed: Jul. 3, 2025

Related U.S. Application Data
(63) Continuation of application No. PCT/JP2023/047301, filed on Dec. 28, 2023.

(30) Foreign Application Priority Data
Jan. 12, 2023 (JP) 2023-003306

(51) Int. Cl. H01L 21/67

(52) U.S. Cl. CPC H01L 21/67276

(57) ABSTRACT

Provided is a non-transitory computer-readable storage medium, an analysis method, and an analyzer that can check a processing state for each processing step in a processing recipe. A non-transitory computer-readable storage medium causes a computer to execute processing of acquiring time series data including measured values measured by a sensor provided in a processing apparatus for processing a substrate according to one or a plurality of processing steps, calculating, for each processing step, based on a plurality of pieces of the time series data acquired when substrates are processed, an indicator value indicating a deviation in measured values among the substrates in a period in which each processing step is executed, and outputting a relationship between each processing step and the indicator value.

### CROSS-REFERENCE TO RELATED APPLICATIONS

This application is a bypass continuation application of international application No. PCT/JP2023/047301 having an international filing date of Dec. 28, 2023, and designating the United States, the international application being based upon and claiming the benefit of priority from Japanese Patent Application No. 2023-003306, filed on Jan. 12, 2023, the entire contents of each are incorporated herein by reference.

### TECHNICAL FIELD

The present disclosure relates to a computer program, an analysis method, and an analyzer.

### BACKGROUND

In a processing process of processing such as etching a substrate such as a semiconductor wafer, it is desirable to stabilize a processing state in order to stabilize substrate quality. In related art, a processing apparatus includes a sensor that acquires data related to the processing state such as temperature, and manages the processing state based on the data acquired by the sensor. PTL 1 discloses a technique of accumulating data related to a processing state, calculating a variation coefficient of the data, and controlling data accumulation based on a value of the variation coefficient.

### CITATION LIST

### Patent Document

PTL 1: JP2014-116453A

### SUMMARY

A substrate processing process is performed according to a processing recipe defining processing contents. The processing recipe includes a plurality of processing steps whose order is determined, and the processing contents are defined in each processing step. In general, the processing contents vary for each processing step, and thus a processing state may vary depending on the processing step. Therefore, it is desirable to check the processing state for each processing step.

The disclosure provides a computer program, an analysis method, and an analyzer that can check a processing state for each processing step in a processing recipe.

A computer program according to an aspect of the disclosure causes a computer to execute processing of acquiring time series data including measured values measured by a sensor provided in a processing apparatus for processing a substrate according to one or a plurality of processing steps, calculating, for each processing step, based on a plurality of pieces of the time series data acquired when substrates are processed, an indicator value indicating a deviation in measured values among the substrates in a period in which each processing step is executed, and outputting a relationship between each processing step and the indicator value.

According to the disclosure, it is possible to provide a computer program, an analysis method, and an analyzer that can check a processing state for each processing step in a processing recipe.

### BRIEF DESCRIPTION OF DRAWINGS

FIG. 1 is a conceptual diagram illustrating a configuration example of an analysis system according to a first embodiment.

FIG. 2 is a conceptual diagram illustrating an example of contents of a processing recipe.

FIG. 3 is a block diagram illustrating an example of an internal configuration of an analyzer.

FIG. 4 is a flowchart illustrating an example of an information processing procedure executed by the analyzer according to the first embodiment.

FIG. 5 is a schematic graph illustrating an example of standardization.

FIG. 6 is a flowchart illustrating an example of a processing procedure of a subroutine of mean F-value calculation processing.

FIG. 7 is a schematic graph illustrating an example of a relationship between a first period and a second period.

FIG. 8 is a schematic diagram illustrating a first example of a chart illustrating a relationship between a processing step and a mean F-value.

FIG. 9 is a schematic diagram illustrating a second example of a chart illustrating the relationship between the processing step and the mean F-value.

FIG. 10 is a graph illustrating an example of a change over time in an F-value.

FIG. 11 is a flowchart illustrating an example of a processing procedure of a subroutine of substrate group processing.

FIG. 12 is a graph illustrating an example of a change in the mean F-value according to an order in which each substrate group is processed.

FIG. 13 is a conceptual diagram illustrating a configuration example of an analysis system according to a second embodiment.

FIG. 14 is a conceptual diagram for illustrating lots and slots.

FIG. 15 is a conceptual diagram for illustrating lots and slots.

FIG. 16 is a flowchart illustrating an example of an information processing procedure executed by an analyzer according to a third embodiment.

FIG. 17 is a schematic diagram illustrating an example of a chart illustrating a relationship between a substrate set and a mean F-value.

FIG. 18 is a schematic diagram illustrating an example of a chart illustrating the relationship between the substrate set and the mean F-value.

FIG. 19 is a chart illustrating an example of a result of calculating a deviation in values obtained by standardizing or normalizing measured values for each substrate set.

FIG. 20 is a conceptual diagram illustrating an example of contents of data pre-processing.

FIG. 21 is a conceptual diagram illustrating an example of a result of principal component analysis.

FIG. 22 is a schematic diagram illustrating an example of an image illustrating a two-dimensional distribution of a plurality of substrate sets.

FIG. 23 is a schematic diagram illustrating an example of a graph illustrating a change over time in values obtained by standardizing or normalizing measured values.

### DETAILED DESCRIPTION

Hereinafter, embodiments will be described in detail with reference to the drawings.

### First Embodiment

A process for manufacturing a substrate such as a semiconductor wafer includes a processing process of processing such as etching the substrate. An apparatus for processing the substrate is referred to as a processing apparatus. For example, the processing apparatus is a process chamber, and processes, such as etches the substrate disposed in the process chamber. The processing apparatus also sequentially processes a plurality of substrates. One substrate is placed in the processing apparatus, processing is executed on the substrate, after the processing is ended, the substrate is extracted from the processing apparatus, a next substrate is placed in the processing apparatus, the same processing is performed, and the processing on the substrate is repeated. In order to stabilize substrate quality, it is desirable that a processing state is stable. In the embodiment, a state of processing performed by the processing apparatus will be analyzed.

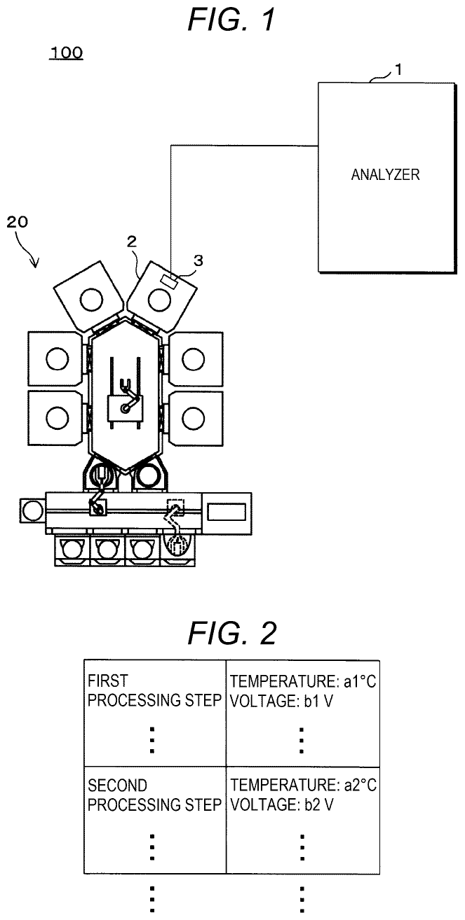

FIG. 1 is a conceptual diagram illustrating a configuration example of an analysis system 100 according to a first embodiment. The analysis system 100 includes a processing apparatus 2, a sensor 3 provided in the processing apparatus 2, and an analyzer 1 that analyzes a state of processing performed by the processing apparatus 2. The processing apparatus 2 is, for example, one process chamber provided in a semiconductor production apparatus 20. The processing apparatus 2 processes a plurality of substrates sequentially. The sensor 3 measures a physical quantity indicating the state of the processing performed by the processing apparatus 2. For example, the processing apparatus 2 is an apparatus that performs plasma etching, and the sensor 3 is a sensor using an optical emission spectrometer (OES) that detects light generated from plasma. The sensor 3 is connected to the analyzer 1. The sensor 3 repeatedly performs measurement and inputs a measured value to the analyzer 1. For example, the sensor 3 performs the measurement every predetermined unit time and inputs the measured value. The sensor 3 measures a plurality of types of physical quantities and inputs a plurality of types of measured values to the analyzer 1. For example, the sensor 3 measures intensities of light having a plurality of different wavelengths and inputs a plurality of types of measured values indicating the intensities of the light having the plurality of wavelengths to the analyzer 1. The analyzer 1 executes an analysis method. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

The processing apparatus 2 processes the substrate with processing contents according to a predetermined processing recipe. The processing recipe includes a plurality of processing steps whose order is determined. Each processing step is a smallest unit of a time series processing procedure for the substrate. In each processing step, contents of processing to be performed on the substrate are determined. FIG. 2 is a conceptual diagram illustrating an example of contents of the processing recipe. The processing recipe includes a plurality of processing steps such as a first processing step and a second processing step. In each processing step, the contents of the processing executed by the processing apparatus 2, such as temperature inside the processing apparatus 2 and a voltage to be applied, are determined. The processing contents include processing conditions. In general, the processing contents vary for each processing step. The processing recipe may include a plurality of processing steps having the same processing contents. Since the order of the plurality of processing steps is determined, processing according to each processing step is executed in the determined order. For example, first, processing according to the first processing step is executed, then processing according to the second processing step is executed, and then processing according to another processing step is executed. The processing recipe may include a single processing step.

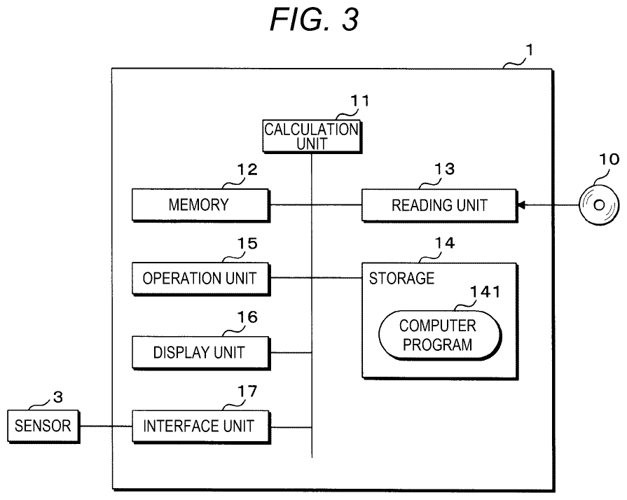

FIG. 3 is a block diagram illustrating an example of an internal configuration of the analyzer 1. The analyzer 1 is implemented using a computer such as a personal computer or a server apparatus. The analyzer 1 includes a calculator 11, a memory 12 that stores temporary data generated along with calculation, a reading unit 13, a storage 14, an operation unit 15, a display unit 16, and an interface unit 17. The calculator 11 is implemented using, for example, a central processing unit (CPU), a graphics processing unit (GPU), or a multi-core CPU. The calculator 11 may also be implemented using a quantum computer. The memory 12 stores temporary data generated along with calculation. The memory 12 is, for example, a random access memory (RAM). The reading unit 13 reads information from a recording medium 10 such as an optical disc or a portable memory. The storage 14 is non-volatile, and is, for example, a hard disk or a non-volatile semiconductor memory.

The operation unit 15 receives an input of information such as text by receiving an operation from a user. The operation unit 15 is, for example, a keyboard, a pointing device, or a touch panel. The display unit 16 displays an image. The display unit 16 is, for example, a liquid crystal display or an electroluminescent display (EL display). The operation unit 15 and the display unit 16 may be integrated. The sensor 3 is connected to the interface unit 17. The interface unit 17 receives the measured values input from the sensor 3.

The calculator 11 causes the reading unit 13 to read a computer program (program product) 141 recorded in the recording medium 10, and causes the storage 14 to store the read computer program 141. The calculator 11 executes processing for implementing functions of the analyzer 1 according to the computer program 141. The computer program 141 is a computer program that causes the analyzer 1 to execute information processing for analyzing the state of the processing performed by the processing apparatus 2. The computer program 141 may be stored in advance in the storage 14 or may be downloaded from outside the analyzer 1. In this case, the analyzer 1 may not be provided with the reading unit 13.

The computer program 141 may be loaded to be executed on a single computer or on a plurality of computers disposed at one site or distributed across a plurality of sites and interconnected by a communication network. That is, the analyzer 1 may be implemented by a plurality of computers, and the computer program 141 may be executed on the plurality of computers connected through the communication network. The analyzer 1 may be implemented using a cloud server.

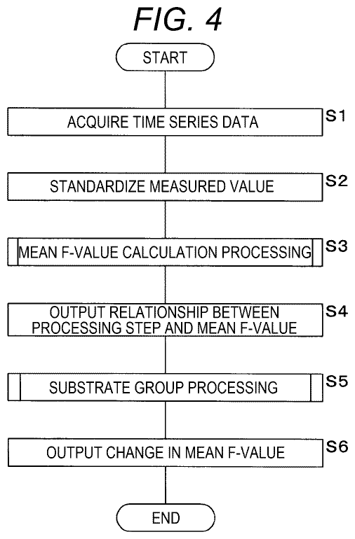

Processing performed by the analysis system 100 will now be described. The processing apparatus 2 processes, such as etches the substrate, and the analyzer 1 analyzes the state of the processing performed by the processing apparatus 2. FIG. 4 is a flowchart illustrating an example of an information processing procedure executed by the analyzer 1 according to the first embodiment. Hereinafter, an information processing step executed by the analyzer 1 will be abbreviated as S. The analyzer 1 executes the following processing by the calculator 11 executing information processing according to the computer program 141.

The processing apparatus 2 processes a plurality of substrates. More specifically, the processing apparatus 2 executes processing sequentially on one substrate according to each processing step in a predetermined processing recipe. After the processing according to the processing recipe is ended, the processing apparatus 2 executes the processing according to the processing recipe on a next substrate from the beginning, and repeats the processing for the plurality of substrates in the same manner. The sensor 3 repeats measurement and inputs a plurality of types of measured values to the analyzer 1. The analyzer 1 receives, at the interface unit 17, the plurality of types of measured values input from the sensor 3, and the calculator 11 stores the received plurality of types of measured values in the storage 14. The analyzer 1 stores, in the storage 14, time series data including a plurality of measured values measured by the sensor 3 in time series, thereby acquiring the time series data (S1).

In S1, the calculator 11 stores, in the storage 14, the time series data for each type of measured value. That is, a plurality of types of time series data are stored. One piece of time series data includes measured values of the same type. The time series data is associated with information indicating the type of measured value. For example, information indicating a wavelength is associated with the time series data. Measured values in the time series data have a determined order. The order of the measured values in the time series data is an order in which the measured values are measured by the sensor 3. For example, each measured value in the time series data is associated with a time when the measured value is measured or a time when the measured value is received by the analyzer 1. In addition, each measured value in the time series data is associated with information indicating during processing execution according to which processing step each measured value is measured. Here, a period in which processing according to one processing step is executed is referred to as a first period. Since the processing recipe includes a plurality of processing steps, a period in which one substrate is processed includes a plurality of first periods. That is, each measured value is associated with information indicating in which first period the measured value is measured.

Since the time series data is acquired for each type of measured value, a plurality of types of time series data are acquired according to processing of one substrate. Each time the substrate is processed, the plurality of types of time series data are obtained. The time series data is associated with information indicating the substrate. An input apparatus to which measurement is input from the sensor 3 and the analyzer 1 may be different apparatuses. The analyzer 1 may execute the processing in S1 by reading the time series data from the input apparatus.

The analyzer 1 then standardizes the measured value in the time series data for each processing step (S2). In S2, the calculator 11 standardizes a plurality of measured values related to each processing step in the time series data. The plurality of measured values related to each processing step are a plurality of measured values measured while the processing apparatus 2 executes processing according to each processing step, that is, a plurality of measured values obtained in each first period. The calculator 11 calculates a mean value and a standard deviation of the plurality of measured values contained in one piece of time series data and obtained in one first period, and performs standardization by dividing, by the standard deviation, a value obtained by subtracting the mean value from each measured value. Let x be the measured value contained in one piece of time series data and obtained in one first period, let x̅ (x with overbar) be the mean value, and let σ be the standard deviation. A standardized measured value xₛₜ is represented by the following formula (1).

$$\begin{matrix}[ Equation 1 ] & \\ {x}_{st} = \frac{x - \overline{x}}{σ} & ( 1 )\end{matrix}$$

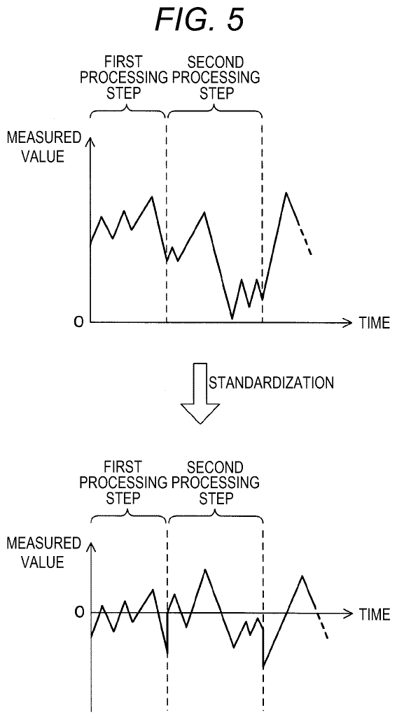

FIG. 5 is a schematic graph illustrating an example of standardization. In FIG. 5, a horizontal axis represents a time, and a vertical axis represents a measured value. In a stage before standardization, the measured value may vary considerably over time. A plurality of measured values related to one processing step are standardized such that a mean value of the plurality of measured values becomes 0 and a variance becomes 1. The calculator 11 performs standardization, using formula (1), on the plurality of measured values related to the plurality of processing steps in one piece of time series data. The calculator 11 similarly performs standardization on the plurality of types of time series data acquired for one substrate. In addition, the calculator 11 similarly performs standardization on the plurality of types of time series data acquired for each of the plurality of substrates. Thereafter, the analyzer 1 performs information processing using the standardized measured values.

The measured value in the time series data may include an influence of an offset where a constant value is added, or a gain where a constant value is multiplied. Therefore, it is difficult to compare raw time series data. When processing steps are different, processing contents are different, and therefore, the offset and the gain may be different. Since the plurality of substrates are not processed at the same time by the same processing apparatus 2, different substrates may have different offsets and gains. By performing standardization for each processing step, the influence of the offset and the gain is removed from the measured value related to each processing step. The mean value and the variance of the measured value related to each processing step are the same across the time series data, and thus it is easy to compare a plurality of measured values related to each processing step across the time series data.

In S2, the analyzer 1 may normalize the measured value for each processing step, instead of performing standardization. In this case, the calculator 11 specifies a maximum value and a minimum value of the plurality of measured values contained in one piece of time series data and obtained in one first period, and performs normalization by dividing a value obtained by subtracting the minimum value from each measured value by a value obtained by subtracting the minimum value from the maximum value. The plurality of measured values related to one processing step are normalized such that the minimum value becomes 0 and the maximum value becomes 1. Thereafter, the analyzer 1 performs information processing using the normalized measured values. When the normalization is performed, the influence of the offset and the gain is still removed from the measured values related to each processing step, and thus it is easy to compare the plurality of measured values related to each processing step across the time series data. The analyzer 1 may perform standardization such that the mean value becomes a value other than 0 or the variance becomes a value other than 1, and may perform normalization such that the minimum value becomes a value other than 0 or the maximum value becomes a value other than 1.

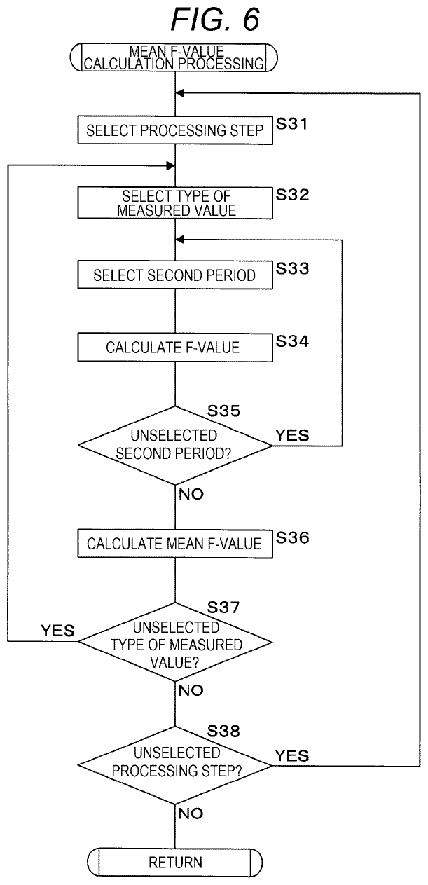

The analyzer 1 then performs a mean F-value calculation processing of calculating a mean of F-values in analysis of variance for each processing step (S3). The mean of the F-values in the analysis of variance is an indicator value that indicates a deviation, among the plurality of substrates, in the measured values in the first period related to each processing step. FIG. 6 is a flowchart illustrating an example of a processing procedure of a subroutine of the mean F-value calculation processing. The analyzer 1 selects a processing step (S31). In S31, the calculator 11 selects one processing step from the plurality of processing steps in the processing recipe. The analyzer 1 then selects the type of measured value (S32). In S32, the calculator 11 selects one type from a plurality of types of measured values measured by the sensor 3. The analyzer 1 then selects a second period in the first period related to the selected processing step (S33).

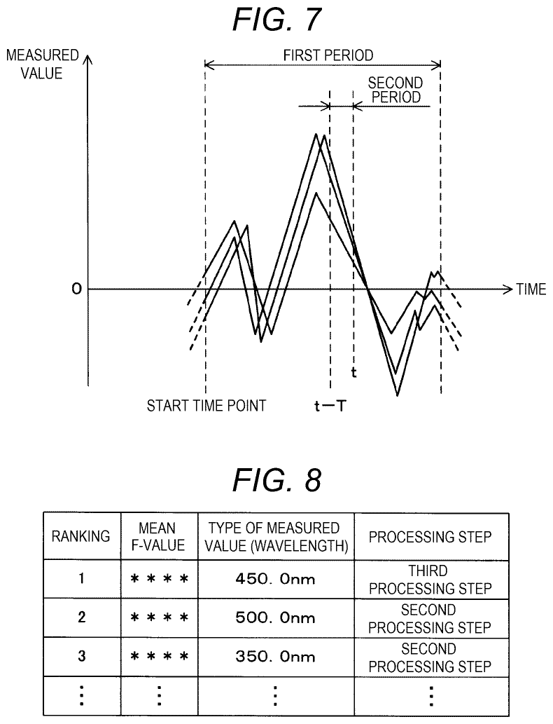

FIG. 7 is a schematic graph illustrating an example of a relationship between the first period and the second period. In FIG. 7, a horizontal axis represents a time, and a vertical axis represents a measured value. A plurality of line graphs illustrated in FIG. 7 illustrate a change over time in the measured value of the selected type in the first period related to the selected processing step when the plurality of substrates are processed by the processing apparatus 2. Although the plurality of substrates are not processed at the same time, the first period related to the same processing step is the same first period. Let t be a natural number, and let time point t be a time point when t times a unit time elapses from a time point when the first period starts. The term “time point” herein is a relative time point in the first period, and is the same time point for the plurality of substrates. Let T be a natural number, and let a period from a time point (t−T) to the time point t be the second period. A length of the second period is T times the unit time, and when the unit time is 0.01 seconds, the length of the second period can be represented by T×0.01 seconds. The second period is a period shorter than the first period. In S33, the calculator 11 selects one second period from a plurality of second periods. The sensor 3 performs measurement once per unit time (for example, 0.01 seconds). Therefore, T measured values are obtained for all the substrates in the second period. The unit time is not limited to 0.01 seconds. A length of the unit time may be appropriately set based on performance of the sensor 3 or a processing capability of the analyzer 1.

The analyzer 1 then calculates the F-values of the analysis of variance for a plurality of measured values obtained in the selected second period (S34). In S34, the calculator 11 calculates the F-values for the plurality of measured values of the selected type in the selected second period for the plurality of substrates. In addition, the calculator 11 calculates each F-value using the measured value standardized or normalized by the processing in S2.

For one substrate, the plurality of measured values of the selected type in the selected second period are collectively treated as one group. Since T measured values are obtained in the second period, one group includes the T measured values. Since one group is obtained corresponding to one substrate, a plurality of groups corresponding to the plurality of substrates are obtained. The F-value is calculated for the plurality of groups. The F-value is a ratio of a deviation in measured values between groups to a deviation in measured values within a group. When the number of substrates processed by the processing apparatus 2 is N, the number of groups is N. The F-value of the analysis of variance is a value obtained by dividing a between-group mean square by a within-group mean square. That is, the F-value is represented by the following formula (2).

F-value=between-group mean square/within-group mean square (2)

The between-group mean square is a value obtained by dividing a between-group sum of squares by a between-group degree of freedom. The between-group sum of squares is a value obtained by multiplying a square of a difference between a mean of measured values in each group and a mean of measured values in all groups by the number of measured values in each group, and summing these products across a plurality of groups. As described above, the number of measured values in each group is T. The between-group degree of freedom is (N−1). Let x̅ᵢ (xᵢ with overbar) be a mean of measured values in an i-th group, let X̅ (X with overbar) be a mean of measured values in all groups, and let MSₐ be the between-group sum of squares. The between-group sum of squares MSₐ is represented by the following formula (3).

$$\begin{matrix}[ Equation 2 ] & \\ {MS}_{a} = \frac{T}{N - 1} {\sum }_{i = 1}^{N} {( {\overline{x}}_{i} - \overline{X} )}^{2} & ( 3 )\end{matrix}$$

The within-group mean square is a value obtained by dividing a within-group sum of squares by a within-group degree of freedom. The within-group sum of squares is a value obtained by summing up sums of squared differences between the measured value and the mean value in each group across a plurality of groups. The within-group degree of freedom is a value obtained by subtracting the number of groups from the number of measured values in all groups, and is (NT-N). Let xᵢⱼ be a j-th measured value in the i-th group, and let MS_{w} be the within-group mean square. The within-group mean square MS_{w} is represented by the following formula (4).

$$\begin{matrix}[ Equation 3 ] & \\ {MS}_{w} = \frac{1}{NT - N} {\sum }_{i = 1}^{N} {\sum }_{j = 1}^{T} {( {x}_{ij} - {\overline{x}}_{i} )}^{2} & ( 4 )\end{matrix}$$

In S34, the calculator 11 calculates the between-group mean square using formula (3), calculates the within-group mean square using formula (4), and calculates the F-value using formula (2). The calculator 11 stores the calculated F-value in the storage 14. The between-group mean square represents a variation in measured values between substrates, and significantly reflects a difference between the substrates. The within-group mean square represents a variation in measured values when one substrate is processed, and reflects magnitude of noise. It becomes clear that, as the F-value increases, the variation in the measured value between the substrates increases as compared to the magnitude of noise. Therefore, by calculating the F-value, magnitude of the deviation in the measured values between the plurality of substrates becomes clear.

The analyzer 1 then determines whether there is any unselected second period (S35). In S35, the calculator 11 determines whether there is any second period, which is not selected yet and for which the F-value is not calculated, among the plurality of second periods in the first period related to the selected processing step. When there is an unselected second period (S35: YES), the analyzer 1 returns the processing to S33. In S33, the calculator 11 selects one second period from second periods that are not selected yet. By repeating S33 to S35, the F-value is calculated for each second period.

When there is no unselected second period (S35: NO), the analyzer 1 calculates a mean F-value (S36). In S36, the calculator 11 calculates the mean F-value by averaging a plurality of F-values calculated for the plurality of second periods. The calculator 11 stores the calculated mean F-value in the storage 14. By calculating the mean F-value, magnitude of a non-instantaneous deviation in the measured values, which occurs in the first period when the processing according to the processing step is performed, is represented instead of an instantaneous deviation in the measured values among the plurality of substrates. For example, the deviation in the measured values among the plurality of substrates, which continues over the first period, is represented by the mean F-value.

The analyzer 1 then determines whether there is any unselected type of measured value (S37). In S37, the calculator 11 determines whether there is any type of measured value, which is not selected yet and for which the mean F-value is not calculated yet, among the plurality of types of measured values. When there is an unselected type of measured value (S37: YES), the analyzer 1 returns the processing to S32. In S32, the calculator 11 selects one type from types of measured values that are not selected yet. By repeating S32 to S37, the mean F-value is calculated for each type of measured value.

When there is no unselected type of measured value (S37: NO), the analyzer 1 determines whether there is any unselected processing step (S38). In S38, the calculator 11 determines whether there is any processing step, which is not selected yet and for which the mean F-value is not calculated yet, among the plurality of processing steps in the processing recipe. When there is an unselected processing step (S38: YES), the analyzer 1 returns the processing to S31. In S31, the calculator 11 selects one processing step from processing steps that are not selected yet. By repeating S31 to S38, the mean F-value is calculated for each processing step and for each type of measured value. When there is no unselected processing step (S38: NO), the analyzer 1 ends the mean F-value calculation processing in S3, and returns the processing to the main routine.

After S3 is ended, the analyzer 1 outputs a relationship between the processing step and the calculated mean F-value (S4). FIG. 8 is a schematic diagram illustrating a first example of a chart illustrating the relationship between the processing step and the mean F-value. “****” in the drawing represents a value of the mean F-value. A plurality of mean F-values created for the plurality of processing steps and the plurality of types of measured values are arranged in descending order of numerical value. In S4, the calculator 11 creates a chart in which the mean F-values are arranged in descending order of numerical value, in association with the processing steps and the types of measured values, and displays the created chart on the display unit 16.

In FIG. 8, as the numerical value of the mean F-value increases, a ranking increases. The mean F-value is associated with a combination of a processing step and a type of measured value. In the example illustrated in FIG. 8, the types of measured values are distinguished by a wavelength of light to be measured. When the mean F-values are arranged in descending order of numerical value, a table in which combinations of the processing steps and the types of measured values are arranged in descending order of the mean F-values is displayed. By arranging the processing steps in descending order of the mean F-values, a processing step where a deviation in the measured values among the plurality of substrates is larger and a processing state is more unstable is extracted. In addition, a type of measured value where a deviation in the measured values among the plurality of substrates is larger is extracted. By checking the relationship between the processing step and the mean F-value as illustrated in FIG. 8, a relatively unstable processing step can be specified. Specifying the unstable processing step can be used to detect an abnormal processing step, determine a defect cause, or improve the processing recipe.

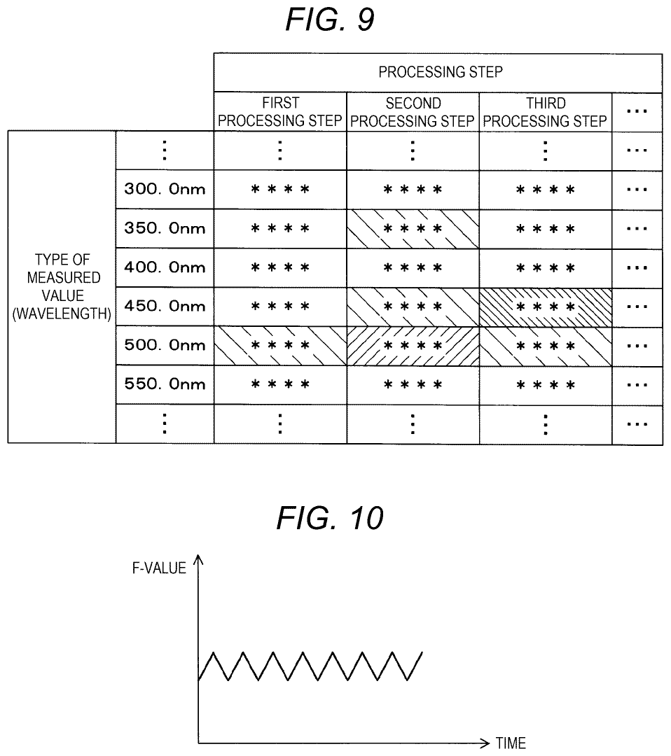

FIG. 9 is a schematic diagram illustrating a second example of the chart illustrating the relationship between the processing step and the mean F-value. “****” in the drawing represents a value of the mean F-value. Values of mean F-values associated with each processing step and each type of measured value are listed. The mean F-values are arranged and displayed in a two-dimensional manner in association with each of the plurality of processing steps arranged in one direction and each of the plurality of types of measured values arranged in a direction intersecting the one direction. A display color of each mean F-value varies according to magnitude of numerical values. As a numerical value increases, the display color emphasizes the mean F-value. Therefore, the chart illustrated in FIG. 9 is a heat map. In FIG. 9, the display color is represented by fill density. In S4, the calculator 11 creates a chart that lists the mean F-values in association with the processing steps and the types of measured values, determines the display color according to the numerical value of each mean F-value, and displays the created chart on the display unit 16. For example, a table in which a range of the numerical value of the mean F-value and the display colors are associated is stored in advance in the storage 14, and the calculator 11 determines the display color with reference to the table. A mean F-value with a large numerical value may be emphasized by varying a display format of the mean F-value other than the display color according to the magnitude of numerical values. For example, darkness of the display color, a size or a thickness of a character, a font of the character, or a thickness of a frame may vary according to the magnitude of numerical values. The mean F-value may be numbered in order of the magnitude of numerical values.

In FIG. 9, the processing step and the type of measured value are associated with each mean F-value, and a mean F-value with a larger numerical value is emphasized in the list of mean F-values. By checking the processing step and the type of measured value associated with the emphasized mean F-value, the processing step and the type of measured value having a greater mean F-value become clear. A processing step where the deviation in the measured values among the plurality of substrates is larger and the processing state is more unstable is extracted. In addition, a type of measured value where the deviation in the measured values is larger is extracted. Similar to the case of using the chart illustrated in FIG. 8, it is possible to specify a relatively unstable processing step. The analyzer 1 may perform processing of outputting a warning when the mean F-value exceeds a predetermined threshold value.

In S4, the analyzer 1 may output a change over time in the F-value. FIG. 10 is a graph illustrating an example of the change over time in the F-value. In FIG. 10, a horizontal axis represents a time, and a vertical axis represents the F-value. The calculator 11 creates a graph illustrating the change over time in the F-value based on the F-value calculated for each time in S3, and displays the graph on the display unit 16. The graph illustrated in FIG. illustrates the change over time in the F-value related to one processing step and one type of measured value. The analyzer 1 can change the processing step and the type of measured value for which the F-value is to be displayed. For example, the analyzer 1 receives a designation of the processing step and the type of measured value by the user operating the operation unit 15, and outputs the change over time in the F-value related to the designated processing step and the designated type of measured value. Graphs illustrating the change over time in the F-value related to a plurality of processing steps or a plurality of types of measured values may be displayed in an overlapping manner. A change over time in the deviation in the measured values becomes clear in more detail by outputting the change over time in the F-value.

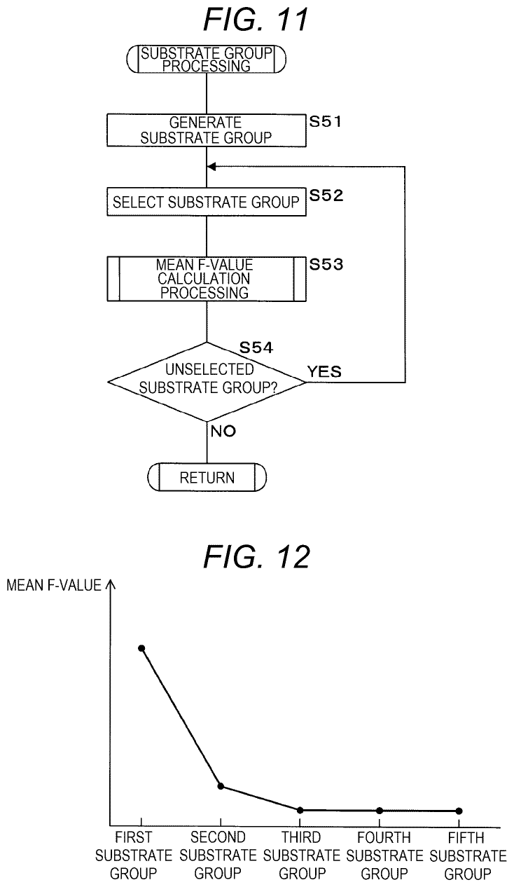

After S4 is ended, the analyzer 1 performs substrate group processing of calculating the mean F-value for each substrate group into which the plurality of substrates processed by the processing apparatus 2 are divided (S5). FIG. 11 is a flowchart illustrating an example of a processing procedure of a subroutine of the substrate group processing. The analyzer 1 generates a plurality of substrate groups into which the plurality of substrates processed by the processing apparatus 2 are divided (S51). In S51, the calculator 11 divides the plurality of substrates processed by the processing apparatus 2 into the plurality of substrate groups each including a plurality of substrates processed consecutively. In addition, the calculator 11 generates the plurality of substrate groups such that a part of the plurality of substrates in the substrate groups overlap each other. The number of substrates in each substrate group is desirably the same. For example, eight substrates are sequentially processed by the processing apparatus 2. A first substrate group including first to fourth substrates, a second substrate group including second to fifth substrates, a third substrate group including third to sixth substrates, a fourth substrate group including fourth to seventh substrates, and a fifth substrate group including fifth to eighth substrates are generated.

The analyzer 1 then selects a substrate group (S52). In S52, the calculator 11 selects one substrate group from the plurality of generated substrate groups. The analyzer 1 then performs mean F-value calculation processing (S53). In S53, the calculator 11 performs the same processing as in S3 to calculate the mean F-value for the plurality of substrates in the selected substrate group. The analyzer 1 then determines whether there is any unselected substrate group (S54). In S54, the calculator 11 determines whether there is a substrate group, which is not selected yet and for which the mean F-value is not calculated yet, among the plurality of substrate groups.

When there is an unselected substrate group (S54: YES), the analyzer 1 returns the processing to S52. In S52, the calculator 11 selects one substrate group from substrate groups which are not selected yet. By repeating S52 to S54, the mean F-value is calculated for each substrate group. When there is no unselected substrate group (S54: NO), the analyzer 1 ends the substrate group processing in S5, and returns the processing to the main routine.

After S5 is ended, the analyzer 1 outputs a change in the mean F-value according to an order in which each substrate group is processed (S6). In S6, based on a processing result in S5, the calculator 11 generates a graph illustrating the change in the mean F-value according to the order in which each substrate group is processed by the processing apparatus 2, and displays the generated graph on the display unit 16. FIG. 12 is a graph illustrating an example of the change in the mean F-value according to the order in which each substrate group is processed. In FIG. 12, a horizontal axis represents distinction of the substrate groups, and a vertical axis represents the mean F-value.

The graph illustrated in FIG. 12 illustrates the change in the mean F-value related to one processing step and one type of measured value. The analyzer 1 can change the processing step and the type of measured value for which the mean F-value is to be displayed. For example, the analyzer 1 receives a designation of the processing step and the type of measured value by the user operating the operation unit 15, and outputs the change in the mean F-value related to the designated processing step and the designated type of measured value. Graphs illustrating the change in the mean F-value related to a plurality of processing steps or a plurality of types of measured values may be displayed in an overlapping manner.

Times when the plurality of substrates in each substrate group are processed by the processing apparatus 2 partially overlap and are slightly shifted between substrate groups. A time when the second substrate group is processed is later than a time when the first substrate group is processed. The first substrate group is processed at an earliest time in a period in which the processing apparatus 2 performs the processing, and the other substrate groups are processed at later times. That is, the change in the mean F-value according to the substrate group indicates the change in the mean F-value according to a time during which the processing by the processing apparatus 2 continues.

In the example illustrated in FIG. 12, a mean F-value related to the first substrate group is large, and a mean F-value related to the second substrate group is small. In addition, mean F-values related to the third substrate group, the fourth substrate group, and the fifth substrate group are smaller and hardly fluctuate. It is illustrated that, although a deviation in measured values is large at the start of the processing by the processing apparatus 2, the deviation in the measured values decreases as the processing continues. Therefore, it becomes clear that the processing state becomes more stable as a time during which the processing continues increases. In this way, by outputting the change in the mean F-value according to the order in which each substrate group is processed, a change in the processing state in each processing step according to the time during which the processing by the processing apparatus 2 continues can be obtained. The analyzer 1 may perform the processing in S5 and S6 such that the substrates in the substrate groups do not overlap each other.

After S6 is ended, the analyzer 1 ends the processing. The analyzer 1 executes the processing in S1 to S6 at a stage when a certain number of substrates are processed by the processing apparatus 2 and the time series data related to each substrate is obtained. For example, the analyzer 1 executes the processing in S1 to S6 periodically or each time a predetermined number of substrates are processed by the processing apparatus 2. The analyzer 1 may execute S4 and S5 in a reverse order. Even when the processing recipe includes a single processing step, the analyzer 1 similarly executes the processing in S1 to S6. The processing in S5 and S6 may be omitted.

As described above, the analyzer 1 acquires the time series data related to the plurality of substrates processed by the processing apparatus 2, calculates the mean F-value for each processing step, and outputs the relationship between each processing step and the indicator value. The mean F-value is an indicator value representing the magnitude of the non-instantaneous deviation in the measured values, which occurs in the period when the processing according to the processing step is performed, instead of the instantaneous deviation in the measured values among the plurality of substrates. Therefore, an overall state of the processing executed according to the processing step is reflected in the mean F-value. The state of the processing executed according to the processing step can be checked according to the calculated mean F-value. In addition, by calculating the mean F-value for each processing step, it is possible to check the state of the processing executed according to the processing step for each of the plurality of processing steps in the processing recipe. For example, as the deviation in the measured values represented by the mean F-value increases, the processing executed according to the processing step is more unstable. By adjusting contents of the processing step such that the mean F-value decreases, stability of the processing executed according to the processing step is improved, and the processing recipe is improved.

### Second Embodiment

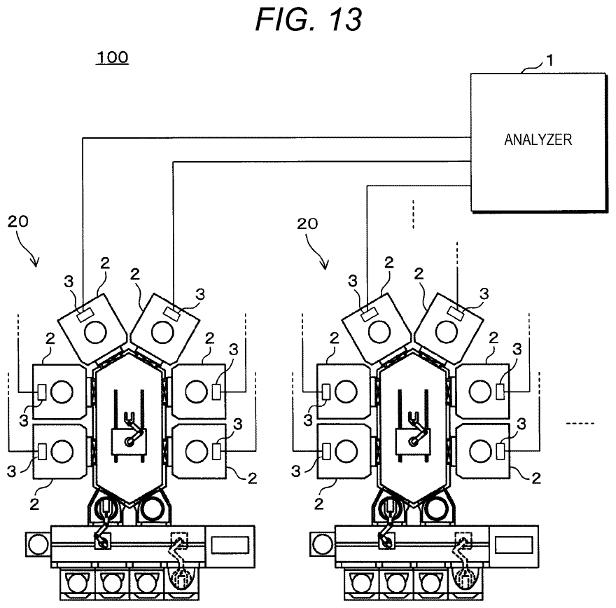

In a second embodiment, the analyzer 1 analyzes substrate processing performed by a plurality of processing apparatuses 2. FIG. 13 is a conceptual diagram illustrating a configuration example of the analysis system 100 according to the second embodiment. The analysis system 100 includes the plurality of processing apparatuses 2. For example, the plurality of processing apparatuses 2 are a plurality of process chambers in one semiconductor production apparatus 20. For example, each of the plurality of processing apparatuses 2 is a process chamber in each of a plurality of semiconductor production apparatuses 20. The sensor 3 provided in each processing apparatus 2 is connected to the analyzer 1. Each processing apparatus 2 independently processes a substrate, and each sensor 3 inputs a measured value to the analyzer 1.

The analyzer 1 receives, by the interface unit 17, measured values input from a plurality of sensors 3 provided in the plurality of processing apparatuses 2, and the calculator 11 stores the received measured values in the storage 14. The analyzer 1 executes the processing in S1 to S4. In S1, the analyzer 1 stores, in the storage 14, a plurality of types of time series data including a plurality of types of measured values measured by each sensor 3 in each processing apparatus 2, thereby acquiring the time series data. The time series data related to substrates processed by different processing apparatuses 2 is acquired by the analyzer 1. An input apparatus to which measurement is input from the sensor 3 may be an apparatus different from the analyzer 1, and the analyzer 1 may execute the processing in S1 by reading the time series data from the input apparatus. The analyzer 1 may read the time series data from a plurality of input apparatuses.

In S2, the analyzer 1 standardizes the measured value in the time series data for each processing step. When the processing apparatuses 2 that process the substrates are different, an offset and a gain may be different. By performing standardization for each processing step, an influence of the offset and the gain is removed from the measured value related to each processing step. Accordingly, even when the time series data relates to a plurality of substrates processed by different processing apparatuses 2, it is easy to compare a plurality of measured values related to each processing step across the time series data. The analyzer 1 may normalize the measured value for each processing step, instead of performing standardization.

In S3, the analyzer 1 calculates, for each processing step, a mean F-value that indicates a deviation in the measured values among the plurality of substrates processed by different processing apparatuses 2. In S5, the analyzer 1 performs substrate group processing of calculating the mean F-value related to a substrate group collecting a plurality of substrates processed at the same time in parallel by the plurality of processing apparatuses 2. The substrate group in the second embodiment is different from the substrate group in the first embodiment. In S51, the analyzer 1 creates the substrate group collecting the plurality of substrates processed at the same time in parallel by the plurality of processing apparatuses 2. At this time, the analyzer 1 creates a plurality of substrate groups with different processing times. A plurality of substrates consecutively processed by the processing apparatus 2 are treated as one lot, and the plurality of processing apparatuses 2 process a plurality of lots sequentially. For example, one substrate group is created by collecting substrates in a specific lot across the plurality of processing apparatuses 2, and a plurality of substrate groups are created by creating a substrate group for each lot. For example, one substrate group is created by collecting one substrate in a specific lot across the plurality of processing apparatuses 2, and a plurality of substrate groups are created by creating a substrate group for each substrate. In S53, the analyzer 1 calculates the mean F-value for each substrate group. In S6, the analyzer 1 outputs a change in the mean F-value according to an order in which each substrate group is processed. After S6 is ended, the analyzer 1 ends the processing. The processing in S5 and S6 may be omitted.

As described above, the analyzer 1 acquires the time series data related to the plurality of substrates processed by the plurality of processing apparatuses 2, calculates, for each processing step, the mean F-value related to the plurality of substrates processed by different processing apparatuses 2, and outputs the relationship between each processing step and the indicator value. In the second embodiment, the state of the processing executed according to the processing step can still be checked according to the mean F-value. For example, since the mean F-value is calculated based on the time series data related to the plurality of substrates processed by different processing apparatuses 2, an influence on the mean F-value due to the processing apparatuses 2 is small, and an influence on the mean F-value due to contents of the processing step is large. Therefore, in the second embodiment, a value of the mean F-value more strongly reflects instability of the processing executed according to the processing step. Based on the mean F-value, it is possible to reliably specify a processing step having low stability, and to effectively improve the processing recipe.

### Third Embodiment

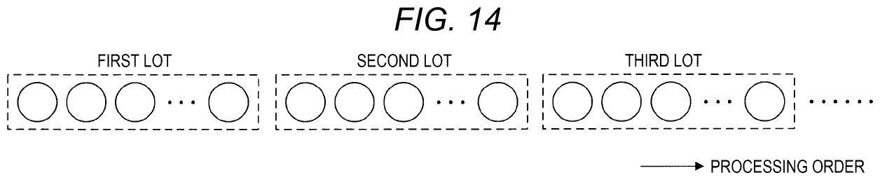

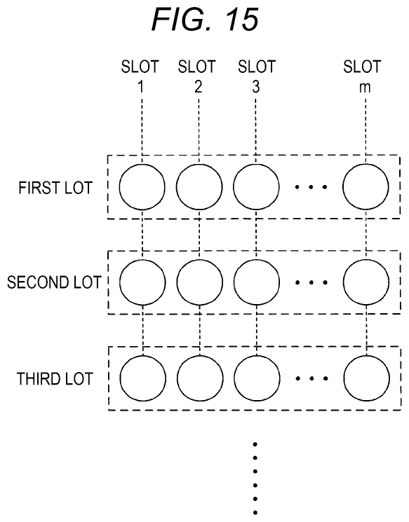

FIGS. 14 and 15 are conceptual diagrams for illustrating lots and slots. A substrate to be processed is indicated by a circle. FIG. 14 illustrates a plurality of substrates to be processed, which are arranged in a processing order. A plurality of substrates processed sequentially by one or a plurality of processing apparatuses 2 are referred to as a lot. After processing for one lot is ended, processing for a next lot is performed. For example, as illustrated in FIG. 14, after a first lot is processed, a second lot is processed, and then a third lot is processed. After the processing for one lot is ended and before the processing for the next lot is started, an environmental change may occur, for example, a predetermined period may elapse, an operator may be changed, or cleaning or maintenance of the processing apparatus 2 may be performed. One lot may include substrates processed by different processing apparatuses 2.

In order to distinguish each substrate in the lot, a slot is used as an index value assigned to each substrate in the lot. The slot is a number assigned, in an order of processing, to a plurality of substrates that may be contained in one lot, regardless of whether the substrates are actually processed. As illustrated in FIG. 15, each lot includes a substrate with a slot 1, a substrate with a slot 2, a substrate with a slot 3, and the like. FIG. 15 illustrates an example in which m substrates are contained in one lot. In a third embodiment, processing for verifying processing stability is performed among a plurality of substrates from different lots with the same slot, or among a plurality of substrates from the same lot with different slots.

In the third embodiment, it is also possible to use a value other than the slot as the index value. The slot is also assigned to a virtual substrate that is not actually processed in the lot. For example, in one lot, a first substrate is processed, no substrate is actually processed when a second substrate is to be processed, and a substrate is processed when a third substrate is to be processed. Slot 1 is assigned to the first substrate, slot 2 is assigned to a virtual substrate that is not actually processed when the second substrate is to be processed, and slot 3 is assigned to the substrate processed when the third substrate is to be processed. The index value may correspond to an actual order of processing performed. In the above example, processing order 1 is assigned to the first substrate, and processing order 2 is assigned to the substrate processed when the third substrate is to be processed.

As the processing order, a “processing order in the lot” or a “processing order in the chamber” may be used. The processing order in the lot is a number assigned to each substrate in an order in which processing is actually performed in the lot. The processing order in the chamber is a number assigned to each substrate, when substrate processing is performed by a plurality of process chambers (processing apparatuses 2) in the lot, in an order of processing for each process chamber in the lot. For example, in one lot, a first substrate is processed by a first process chamber, second and third substrates are processed by a second process chamber, and a fourth substrate is processed by the first process chamber. The “processing order in the lot” is 1, 2, 3, and 4 in the order of the first, second, third, and fourth substrates. The first substrate has a “processing order in the chamber” 1 with respect to the first process chamber, the second and third substrates have “processing orders in the chamber” 1 and 2 with respect to the second process chamber, and the fourth substrate has a “processing order in the chamber” 2 with respect to the first process chamber.

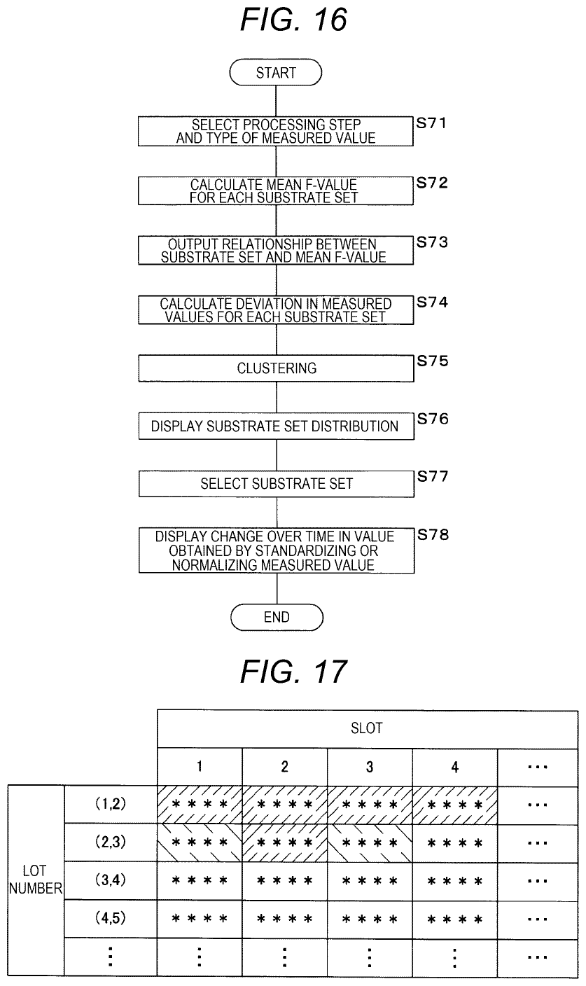

A configuration of the analysis system 100 is the same as that in the first or second embodiment. FIG. 16 is a flowchart illustrating an example of an information processing procedure executed by the analyzer 1 according to the third embodiment. For example, the analyzer 1 executes the following processing after the processing in S1 to S6 is ended or after the processing in S1 to S4 is ended. The analyzer 1 selects the processing step and the type of measured value (S71). In S71, the calculator 11 receives a designation of the processing step and the type of measured value by the user operating the operation unit 15, selects a designated processing step from the plurality of processing steps, and selects a designated type of measured value from the plurality of types of measured values. For example, a chart illustrating the relationship between the processing step and the mean F-value as illustrated in FIG. 8 is displayed, and the designation of the processing step and the type of measured value is input to the analyzer 1 by the user operating the operation unit 15.

The analyzer 1 then calculates the mean F-value for each substrate set including a plurality of specific substrates, with respect to the selected processing step and the selected type of measured value (S72). In S72, the calculator 11 specifies a substrate set including a plurality of substrates from different lots with the same slot, and a substrate set including a plurality of substrates from the same lot with different slots. Each lot is assigned a lot number in an order of processing. For example, the lot number of the first lot is 1, and the lot number of the second lot is 2.

The calculator 11 specifies a substrate set by selecting a plurality of substrates with the same slot from a plurality of lots whose lot numbers are consecutive. In addition, the calculator 11 specifies a substrate set by selecting a plurality of substrates with consecutive slots in the same lot. For example, each substrate set includes two substrates. The calculator 11 may specify a substrate set including three or more substrates. The calculator 11 specifies a plurality of substrate sets. For example, the calculator 11 specifies substrate sets for all combinations of consecutive lot numbers and slots, and for all combinations of lot numbers and consecutive slots.

In S72, the calculator 11 calculates the mean F-value for the plurality of substrates in the substrate set. Data used for the calculation is a value obtained by standardizing or normalizing the measured value of the selected type obtained when the selected processing step is executed on each of the plurality of substrates in the substrate set. The calculator 11 performs the same processing as that in S3 to calculate the mean F-value. The calculator 11 calculates the mean F-value for all substrate sets. The calculator 11 stores, in the storage 14, the mean F-value calculated for each substrate set. In S72, the calculator 11 may calculate the mean F-value for a substrate set including a plurality of substrates from different lots with the same processing order, and for a substrate set including a plurality of substrates from the same lot with different processing orders.

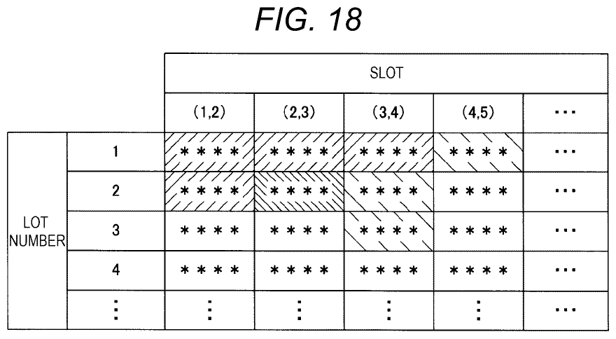

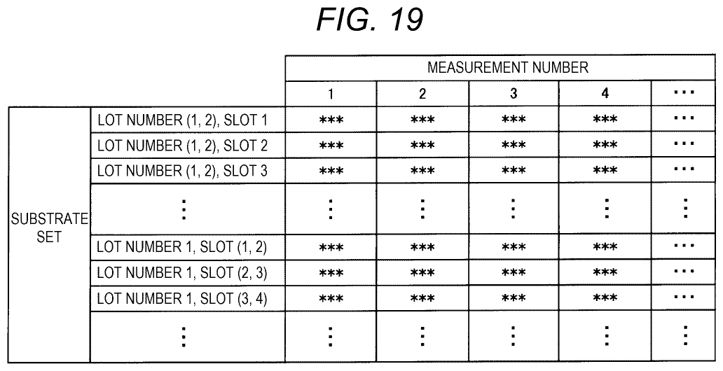

The analyzer 1 outputs a relationship between the substrate set and the mean F-value (S73). FIGS. 17 and 18 are schematic diagrams illustrating examples of charts illustrating the relationship between the substrate set and the mean F-value. “****” in the drawing represents a value of the mean F-value. FIG. 17 is a table in which mean F-values are arranged in association with each substrate set including a plurality of substrates from different lots with the same slot. In the drawing, at a position where the slot and a combination of a plurality of lot numbers intersect with each other, a mean F-value related to a substrate set including a plurality of substrates specified by the plurality of lot numbers and the slot is displayed. FIG. 18 is a table in which mean F-values are arranged in association with each substrate set including a plurality of substrates from the same lot with different slots. In the drawing, at a position where a lot number and a combination of a plurality of slots intersect with each other, a mean F-value related to a substrate set including a plurality of substrates specified by the lot number and the plurality of slots is displayed.

In S71, the calculator 11 creates a table in which the mean F-values are arranged in association with the respective substrate sets as illustrated in FIGS. 17 and 18, and displays the table on the display unit 16. The calculator 11 creates two types of charts. One chart, as illustrated in FIG. 17, is a chart illustrating the relationship between the mean F-value and the substrate set including the plurality of substrates from different lots with the same slot. The other chart, as illustrated in FIG. 18, is a chart illustrating the relationship between the mean F-value and the substrate set including the plurality of substrates from the same lot with different slots. For example, the calculator 11 displays the two types of charts on the display unit 16 at the same time. The calculator 11 may display one chart on the display unit 16, and change the displayed chart to the other chart in response to the user operating the operation unit 15 to input an instruction to change the chart.

In the charts illustrated in FIGS. 17 and 18, a display color of the mean F-value varies according to magnitude of numerical values. As a numerical value increases, the display color emphasizes the mean F-value. In FIGS. 17 and 18, the display color is represented by fill density. The calculator 11 determines the display color according to the numerical value of the mean F-value, and adjusts the display color. A method for determining the display color is the same as that in the first embodiment. A display format of the mean F-value other than the display color may vary according to the magnitude of numerical values, for example, darkness of the display color, a size or a thickness of a character, a font of the character, or a thickness of a frame may vary according to the magnitude of numerical values. A table in which the substrate set and the mean F-value are associated is displayed, the display format of the mean F-value varies according to the magnitude of numerical values, and thus a substrate set which has a large mean F-value and whose processing is unstable can be easily specified.

FIG. 17 illustrates the mean F-value representing a deviation in measured values among the plurality of substrates from different lots with the same slot. Processing stability or instability across a plurality of lots is visualized. Since the measured values are compared for the same slot, there is no influence due to a difference in slots, and processing instability due to a difference in lots becomes clear. A combination of consecutive lots where the mean F-value increases becomes clear, and a combination of lots where a substrate processing state is unstable between lots becomes clear. For example, when the mean F-value becomes large in a combination of lots having small lot numbers and becomes smaller in a combination of lots having larger lot numbers, it is inferred that the processing state is stabilized as the substrate processing continues. For example, when the mean F-value suddenly increases, it is inferred that there is a certain environmental change between lots.

FIG. 18 shows the mean F-value representing a deviation in measured values among the plurality of substrates from the same lot with different slots. Processing stability or instability across a plurality of slots in the lot is visualized. Since the measured values are compared for the same lot, there is no influence due to a difference in lots, and processing instability due to a difference in slots becomes clear. A combination of consecutive slots where the mean F-value increases in the lot becomes clear, and a combination of slots where the substrate processing state is unstable between slots becomes clear. For example, when the mean F-value becomes large in a combination of small slots and becomes smaller in a combination of larger slots, it is inferred that the processing state is stabilized as the substrate processing continues in the lot. In addition, it is possible to specify a slot where the processing becomes unstable suddenly. In S73, the calculator 11 may display, on the display unit 16, a table in which the mean F-values are arranged in association with the substrate set including the plurality of substrates from different lots with the same processing order, or the substrate set including the plurality of substrates from the same lot with different processing orders.

The analyzer 1 calculates, for each substrate set, a deviation in values obtained by standardizing or normalizing the measured values among the plurality of sub strates in the substrate set (S74). During the first period in which the processing according to the processing step is executed, the sensor 3 repeats the measurement, and the measured values are obtained at predetermined intervals. Measurement numbers are assigned to the plurality of measured values obtained during the first period in an order of measurement. In the first period, first, a measured value of measurement number 1 is obtained, then a measured value of measurement number 2 is obtained, and measured values are obtained successively. An increase in the measurement number corresponds to passage of time within the first period. In S74, the calculator 11 calculates a difference between the values obtained by standardizing or normalizing the measured values having the same measurement number among the plurality of substrates, thereby calculating a deviation in the values obtained by standardizing or normalizing the measured values.

FIG. 19 is a chart illustrating an example of a result of calculating the deviation in the values obtained by standardizing or normalizing the measured values for each substrate set. In one substrate set, the difference between the values obtained by standardizing or normalizing the measured values is calculated for each measurement number, and the difference between the values obtained by standardizing or normalizing the measured values is calculated for each substrate set. In the drawing, “****” represents the difference between the values obtained by standardizing or normalizing the measured values. In FIG. 19, a difference value is illustrated in association with the lot number and the slot for specifying the substrate set, and the measurement number. The calculator 11 calculates the difference between the values obtained by standardizing or normalizing the measured values for all substrate sets and for all measurement numbers. As an absolute value of the difference increases, the deviation in the values obtained by standardizing or normalizing the measured values among the plurality of substrates increases. The calculator 11 stores data representing the calculated deviation in the storage 14 as illustrated in FIG. 19.

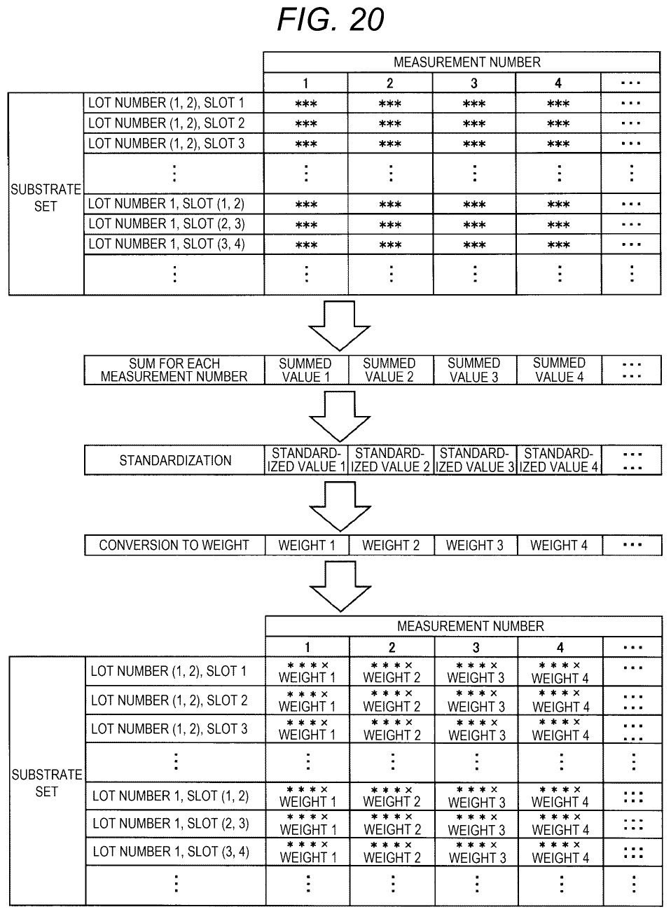

The analyzer 1 then performs clustering of a plurality of substrate sets based on the calculated deviation (S75). In S75, first, the calculator 11 performs pre-processing on the data representing the deviation to emphasize a measured value number with a large deviation in the measured values. FIG. 20 is a conceptual diagram illustrating an example of contents of the data pre-processing. The calculator 11 sums difference values calculated for the plurality of substrate sets for each measurement number. In the drawing, values obtained by summing the difference values calculated for measurement number 1, measurement number 2, and the like across the plurality of substrate sets are illustrated as summed value 1, summed value 2, and the like.

The calculator 11 standardizes the calculated summed values such that a mean is 0 and a standard deviation is 1. For example, the calculator 11 standardizes the summed values by performing calculation similar to that in formula (1) on the summed values calculated for the plurality of measurement numbers. In the calculation, x in formula (1) is the summed value, x̅ is the mean of the summed values, σ is the standard deviation of the summed values, and xₛₜ is a value obtained by standardizing the summed value. In the drawing, values obtained by standardizing summed value 1, summed value 2, and the like are illustrated as standardized value 1, standardized value 2, and the like.

The calculator 11 converts the calculated standardized values into weights. For example, the calculator 11 converts the standardized values into the weights using a softmax function. Assuming that the number of measured values obtained in the first period is M, a standardized value for a measurement number i is xᵢ, and a weight is Wᵢ, the calculator 11 calculates the weight Wᵢ according to formula (5) below.

$$\begin{matrix}[ Equation 4 ] & \\ {W}_{i} = \frac{{e}^{{x}_{i}}}{{\sum }_{j = 1}^{M} {e}^{{x}_{i}}} & ( 5 )\end{matrix}$$

In FIG. 20, weights obtained by converting standardized value 1, standardized value 2, and the like are illustrated as weight 1, weight 2, and the like. Using the softmax function, the weights become positive values, and a sum of the weights becomes 1. The calculator 11 multiplies the weight calculated for each measurement number by the difference between the values obtained by standardizing or normalizing the measured values. As illustrated in FIG. 20, each difference value calculated for measurement number 1 is multiplied by weight 1, each difference value calculated for measurement number 2 is multiplied by weight 2, and the same applies to measurement number 3 and subsequent numbers. By performing such pre-processing, a value indicating a large deviation in the measured values is converted into a relatively larger value.

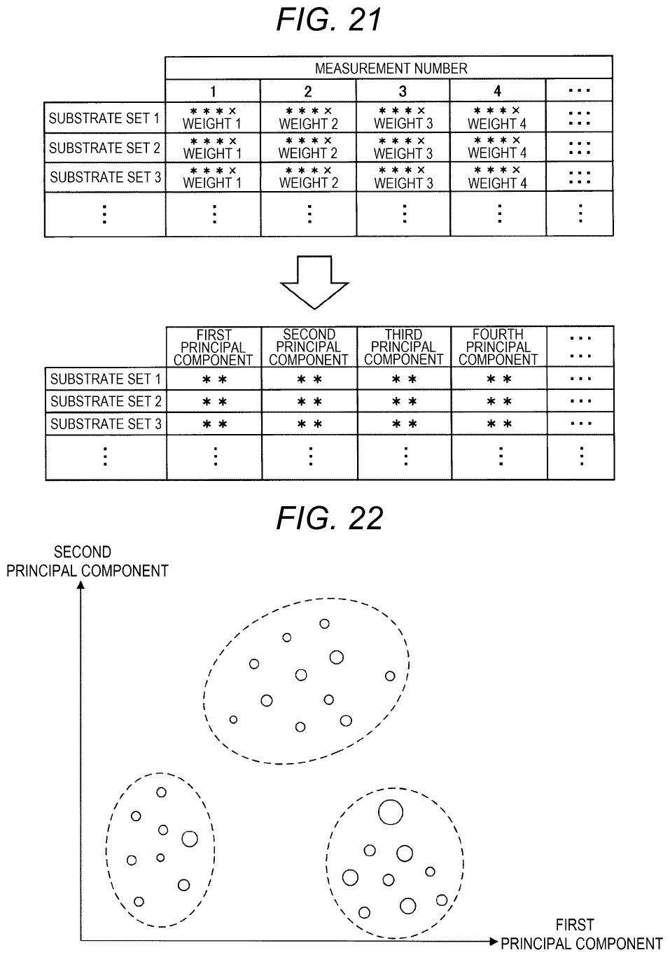

The calculator 11 then extracts, from the plurality of substrate sets, a predetermined number of substrate sets in descending order of the mean F-value. For example, the number of sets to be extracted is 100. The calculator 11 performs principal component analysis on data after pre-processing related to the plurality of extracted substrate sets. FIG. 21 is a conceptual diagram illustrating an example of a result of the principal component analysis. In the drawing, the extracted substrate sets are illustrated as substrate set 1, substrate set 2, and the like. In each substrate set, values after pre-processing obtained for a plurality of measurement numbers are converted into a plurality of principal components. In the drawing, “**” represents a principal component value (principal component score).

The calculator 11 performs substrate set clustering using the principal component value. For example, the calculator 11 performs clustering using a k-means method. At this time, the calculator 11 performs clustering using a predetermined number of principal components, such as using a first principal component, a second principal component, and a third principal component. In this way, the calculator 11 performs clustering after dimension reduction. The calculator 11 may perform dimension reduction and clustering using a uniform manifold approximation and projection (UMAP) method. By clustering, the plurality of substrate sets are classified into a plurality of clusters each including substrate sets having a similar deviation in the measured values.

The calculator 11 then displays a distribution of the plurality of clustered substrate sets (S76). In S76, the calculator 11 creates an image representing a two-dimensional distribution of the plurality of clustered substrate sets, and displays the created image on the display unit 16. FIG. 22 is a schematic diagram illustrating an example of the image illustrating the two-dimensional distribution of the plurality of substrate sets. In the drawing, a horizontal axis represents a value of the first principal component, and a vertical axis represents a value of the second principal component. Each circle in the drawing indicates a substrate set having the value of the first principal component and the value of the second principal component corresponding to two-dimensional coordinates. The clusters are distinguished by enclosing substrate sets in the same cluster with a dashed line. The calculator 11 may make display colors of substrate sets in different clusters different from each other.

The calculator 11 changes a display size of the substrate set according to the mean F-value. For example, as the mean F-value increases, the display size increases. In addition to the display size, a display format of the substrate set may be changed according to the mean F-value. For example, darkness of the display color may be changed according to the mean F-value, and a shape of a mark indicating the substrate set may be changed according to the mean F-value. By varying the display format, a substrate set having a large mean F-value, that is, having a large deviation in the measured values becomes clear.

When the two-dimensional distribution of the clustered substrate sets is displayed, it becomes clear what type of deviation in the measured values occurs frequently. By changing the display format of the substrate set according to the mean F-value, it becomes clear which cluster containing what type of deviation in the measured values includes a substrate set having a large deviation in the measured values. It also becomes clear to what extent there exist other substrate sets having a deviation in the measured values similar to that of a specific substrate set. For example, it is also possible to check a frequency of occurrence of a specific abnormality. In S76, the calculator 11 may display an image representing a three-dimensional distribution of the plurality of clustered substrate sets on the display unit 16.

In the processing in S74 to S76, the analyzer 1 may calculate the deviation in the values obtained by standardizing or normalizing the measured values using a method other than calculating the difference. For example, the calculator 11 may calculate the deviation by calculating a variance of the values obtained by standardizing or normalizing the measured values related to the plurality of substrates. As a method for pre-processing the data, other methods may be used. Alternatively, the principal component analysis may be performed without pre-processing the data. In addition, as a method for performing the dimension reduction, a method other than the principal component analysis may be used.

The analyzer 1 selects one substrate set from the plurality of substrate sets (S77). In S77, the calculator 11 receives an instruction to select one substrate set by the user operating the operation unit 15, and selects a designated substrate set from the plurality of substrate sets. For example, in the processing in S73, the user operates the operation unit 15 to select any one of the substrate sets in a state where a table in which mean F-values are arranged in association with the respective substrate sets as illustrated in FIGS. 17 and 18 is displayed on the display unit 16. For example, any substrate set having a large mean F-value is selected. Alternatively, in a state where the distribution of the plurality of clustered substrate sets as illustrated in FIG. 22 is displayed by the processing in S76, the user operates the operation unit 15 to select any one of the substrate sets. For example, any substrate set in a specific cluster is selected.

The analyzer 1 then displays a change over time in the values obtained by standardizing or normalizing the measured values obtained for the selected substrate set (S78). In S78, a graph illustrating the change over time in the values obtained by standardizing or normalizing the measured values obtained during the first period for the plurality of substrates in the substrate set is displayed. The calculator 11 creates the graph and displays the created graph on the display unit 16.

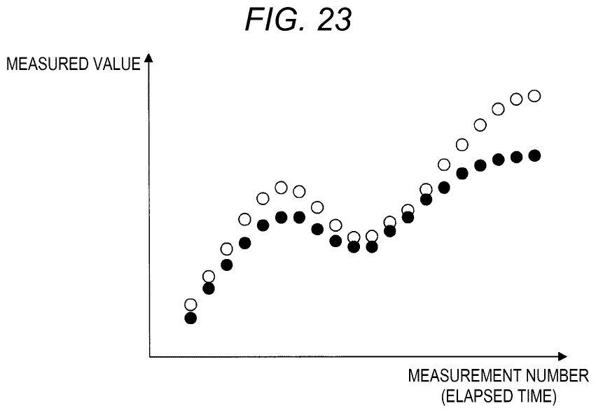

FIG. 23 is a schematic diagram illustrating an example of the graph illustrating the change over time in the values obtained by standardizing or normalizing the measured values. In the drawing, a horizontal axis represents a measurement number. The measurement number corresponds to an elapsed time within the first period. In the drawing, a vertical axis represents a value obtained by standardizing or normalizing a measured value. In the drawing, the value obtained by standardizing or normalizing the measured value is simply referred to as the measured value. In FIG. 23, a value obtained by standardizing or normalizing a measured value for one substrate among the plurality of substrates in the substrate set is indicated by a white circle, and a value obtained by standardizing or normalizing a measured value for another substrate is indicated by a black circle. The change over time in the measured value within the first period is specifically illustrated, and it becomes clear how the measured value specifically deviates among the plurality of substrates.

The change over time in the value obtained by standardizing or normalizing the measured value for the selected substrate set is displayed, and thus it becomes clear at which moment during the first time the deviation in the measured values occurs. In addition, it becomes clear how the change over time in the measured values among the plurality of substrates specifically changes with respect to the selected substrate set. The user can easily check such information, which can contribute to improvement in the processing step.

After S78 is ended, the analyzer 1 ends the processing. The analyzer 1 may repeat the processing in S77 and S78. For example, various substrate sets may be selected, and the processing of displaying the change over time in the value obtained by standardizing or normalizing the measured value may be performed for each substrate set. It is not always required to perform all the processing in S71 to S78, the processing may be performed without S73, the processing may be performed without S74 to S76, or the processing may be performed without S71 to S78.

In the third embodiment, an example has been described in which the substrate set including the plurality of substrates from different lots with the same index value and the substrate set including the plurality of substrates from the same lot with different index values are both used as the substrate sets. The analyzer 1 may perform processing of handling only one of the substrate sets.

The first to third embodiments have been described using an example in which the mean F-value is used as the indicator value that indicates the deviation in the measured values among the plurality of substrates in the period in which the processing according to each processing step is executed. The analyzer 1 may calculate an indicator value other than the mean F-value. For example, the analyzer 1 may calculate variances, standard deviations, or coefficients of variation at a plurality of time points in the first period, and may calculate a mean of the variances, the standard deviations, or the coefficients of variation as the indicator value. The processing apparatus 2 may be an apparatus for processing a substrate other than a semiconductor wafer, such as a glass substrate or a flat panel substrate.

The first to third embodiments show an aspect in which a plurality of types of measured values are acquired using one sensor 3. The analysis system 100 may have an aspect in which the processing apparatus 2 includes a plurality of sensors 3 for measuring physical quantities of different types and a plurality of types of measured values are acquired using the plurality of sensors 3. The first to third embodiments show an example in which the sensor 3 measures the intensity of light, and alternatively, there may be an aspect in which the sensor 3 measures a physical quantity other than the intensity of light, such as temperature or pressure. The analysis system 100 may have an aspect in which the processing apparatus 2 includes a plurality of sensors 3 for measuring the same type of physical quantity and measured values measured by the plurality of sensors 3 are acquired as a plurality of types of measured values. For example, the processing apparatus 2 may be provided with a plurality of sensors 3 that measure temperature at a plurality of locations inside the processing apparatus 2, and the temperature at the plurality of locations may be acquired as a plurality of types of measured values. The first to third embodiments show an aspect in which a plurality of types of measured values are acquired, and alternatively, there may be an aspect in which the processing apparatus 2 is provided with a single sensor 3 for measuring a single physical quantity and the analyzer 1 acquires a single type of measured value.

It shall be understood that the embodiments disclosed herein are illustrative and are not restrictive in all aspects. The embodiment described above may be omitted, replaced, or modified in various forms without departing from the scope and spirit of the appended claims.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the disclosure is not limited thereto. The claims may also be described using a format of multi-claims reciting at least one multi-claim (multi-multi claims).

1. A non-transitory computer-readable storage medium having computer-executable instructions stored thereon, which when executed by a processor, cause the processor to perform a method comprising:
acquiring time series data including measured values measured by a sensor provided in a processing apparatus for processing a substrate according to one or a plurality of processing steps;
calculating, for each processing step, based on a plurality of pieces of the time series data acquired when substrates are processed, an indicator value indicating a deviation in measured values among the substrates in a period in which each processing step is executed; and
outputting a relationship between each processing step and the indicator value.

2. The non-transitory computer-readable storage medium according to claim 1, wherein the method further comprises:
standardizing or normalizing, for each processing step, measured values which are included in the time series data related to each substrate and which are measured during a period in which each processing step is executed; and
calculating the indicator value using the measured values after the standardization or normalization.

3. The non-transitory computer-readable storage medium according to claim 1, wherein the method further comprises:
treating measured values measured in each of second periods in a first period in which each processing step is executed as one group, and calculating, with respect to groups for the substrates, a ratio of a deviation in measured values between the groups to a deviation in the measured values within the respective groups; and
calculating, as the indicator value, a mean value of the ratios calculated for the second periods.

4. The non-transitory computer-readable storage medium according to claim 1, wherein the method further comprises:
acquiring a plurality of types of time series data including a plurality of types of measured values measured by one or a plurality of sensors provided in the processing apparatus;
calculating the indicator value for each type of the measured values; and
outputting a relationship among each type of the measured values, each processing step, and the indicator value.

5. The non-transitory computer-readable storage medium according to claim 4, wherein the method further comprises measuring intensities of light having different wavelengths.

6. The non-transitory computer-readable storage medium according to claim 4, wherein the method further comprises: processing of displaying combinations of the processing steps and the types of measured values arranged in order of magnitude of the indicator value.

7. The non-transitory computer-readable storage medium according to claim 4, wherein the method further comprises:
displaying a table in which the indicator value is arranged in association with each processing step and each type of the measured values, and
varying a display format of the indicator value according to magnitude of the indicator value.

8. The non-transitory computer-readable storage medium according to claim 1, wherein the method further comprises:
dividing substrates processed by a same processing apparatus into substrate groups each including substrates that are consecutively processed,
calculating the indicator value for each substrate group, and
outputting a relationship between each substrate group and the indicator value.

9. The non-transitory computer-readable storage medium according to claim 8, wherein the method further comprises displaying a graph illustrating a change in the indicator value according to an order in which the respective substrate groups are processed by the processing apparatus.

10. The non-transitory computer-readable storage medium according to claim 8, wherein
a part of the substrates in each substrate group overlaps another substrate group.

11. The non-transitory computer-readable storage medium according to claim 1, wherein the method further comprises:
calculating the indicator value for each of a plurality of substrate sets, the plurality of substrate sets including substrates from different lots and having a same index value assigned to the substrates in each lot, or including substrates from a same lot and having different index values,
displaying a table in which the indicator value is arranged in association with each of the plurality of substrate sets, and
varying a display format of the indicator value according to magnitude of the indicator value.

12. The non-transitory computer-readable storage medium according to claim 2, wherein the method further comprises:
calculating a deviation in values obtained by standardizing or normalizing measured values measured during a first period in which one of the processing steps is executed between substrates from different lots and having a same index value, or between substrates from a same lot and having different index values,
clustering, based on the deviation, substrate sets each including substrates from different lots and having a same index value, or substrates from a same lot and having different index values, and
displaying a distribution of clustered substrate sets.

13. The non-transitory computer-readable storage medium according to claim 2, wherein the method further comprises:
selecting one of the processing steps,
selecting one substrate set from substrate sets each including substrates from different lots and having a same index value or substrates from a same lot and having different index values, and
displaying a change over time in values obtained by standardizing or normalizing measured values measured during a first period in which the selected processing step is executed on the substrates in the selected substrate set.

14. An analysis method comprising:
acquiring time series data including measured values measured by a sensor provided in a processing apparatus for processing a substrate according to one or a plurality of processing steps;
calculating, for each processing step, based on a plurality of pieces of the time series data acquired when substrates are processed, an indicator value indicating a deviation in measured values among the substrates in a period in which each processing step is executed; and
outputting a relationship between each processing step and the indicator value.

15. An analyzer comprising:
processing circuitry configured to:
acquire time series data including measured values measured by a sensor provided in a processing apparatus for processing a substrate according to one or a plurality of processing steps,
calculate, for each processing step, based on a plurality of pieces of the time series data acquired when substrates are processed, an indicator value indicating a deviation in measured values among the substrates in a period in which each processing step is executed, and
output a relationship between each processing step and the indicator value.

16. The analyzer according to claim 15, wherein the processing circuitry is further configured to:
standardize or normalize, for each processing step, measured values which are included in the time series data related to each substrate and which are measured during a period in which each processing step is executed, and
calculate the indicator value using the measured values after the standardization or normalization.

17. The analyzer according to claim 15, wherein the processing circuitry is further configured to:
treat measured values measured in each of second periods in a first period in which each processing step is executed as one group, and calculating, with respect to groups for the substrates, a ratio of a deviation in measured values between the groups to a deviation in the measured values within the respective groups, and
calculate, as the indicator value, a mean value of the ratios calculated for the second periods.

18. The analyzer according to claim 15, wherein the processing circuitry is further configured to:
acquire a plurality of types of time series data including a plurality of types of measured values measured by one or a plurality of sensors provided in the processing apparatus,
calculate the indicator value for each type of the measured values, and
output a relationship among each type of the measured values, each processing step, and the indicator value.

19. The analyzer according to claim 18, wherein the processing circuitry is further configured to measure intensities of light having different wavelengths.

20. The analyzer according to claim 15, wherein the processing circuitry is further configured to:
calculate the indicator value for each substrate set including substrates from different lots and having a same index value assigned to the substrates in each lot, or for each substrate set including substrates from a same lot and having different index values,
display a table in which the indicator value is arranged in association with each of substrate sets, and
vary a display format of the indicator value according to magnitude of the indicator value.
